(19) United States
(12) Patent Application Publication
(10) Pub. No.: US 2002/0188541 A1
(43) Pub. Date: Dec. 12, 2002

(54) Methods and systems for soliciting, submitting and managing appraisals

(76) Inventors: John A. Josko, Vernon Hills, IL (US); Sheila Barry, Somers, NY (US); Kary Lesser, Woodbury, CT (US); Vincent Mendez, Southbury, CT (US); Daniel L. Kearns, Southbury, CT (US); Mark Arditti, Ridgefield, CT (US); Rabia Shaffeeullah, Danbury, CT (US); David K. Price, Monroe, CT (US)

Correspondence Address: John S. Beulick, Armstrong Teasdale LLP, Suite 2600, One Metropolitan Sq., St. Louis, MO, 63102, US

(21) Appl. No.: 09/878,685

(22) Filed: Jun. 11, 2001

(51) Int. Cl. G06F 17/60

(52) U.S. Cl. 705/36; 705/35

(57) ABSTRACT

Methods and systems for soliciting, submitting, and managing appraisals are described. In one embodiment, the method includes the steps of notifying at least one appraiser of an appraisal request, receiving, in electronic form, an appraisal from the appraiser, and storing the received appraisal, in electronic form, in a memory.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to asset management, and more particularly, to managing an asset valuation process and enhancing the usefulness of existing valuations.

For at least some financial transactions, a financial institution may require an appraisal of an asset subject to the transaction. For example, if a financial institution is considering a loan to a customer for the purchase of an asset, and if the asset is intended to serve as collateral for the loan, then the financial institution may require that an appraisal of the asset be obtained. Some financial institutions may enter into thousands of such transactions, and securing and storing appraisals on such assets can be tedious and time consuming.

Typically, appraisals are provided to a financial institution in paper form. Especially for financial institutions that enter into thousands of financial transactions that require appraisals, such appraisals may not necessarily be stored in a manner that facilitates easy retrieval. Just locating an appraisal related to a financial transaction that may have been entered into many years earlier can be difficult.

Due to a high volume of appraisals required by at least some financial institutions, and the difficulties associated with retrieving any one of such appraisals when needed, e.g., due to a default, financial institutions may also have difficulty in evaluating appraiser performance. For example, if an asset serving as collateral for a loan is sold during the loan term at a price lower than the value assigned to the asset by the appraiser, the financial institution may not necessarily even be able to locate the appraisal to determine whether the appraiser assigned too high of a value to the asset. Similarly, if the asset is sold for the appraised value, the financial institution may not be able to determine that the appraisal was correct unless the appraisal can be located.

Further, information contained in an appraisal may be useful for purposes in addition to determining a value for a specific asset. For example, a financial institution may regularly extend loans in a particular industry, and the assets that serve as collateral for such loans may be very similar from loan to loan. Separate appraisals are typically obtained in connection with each transaction, however, and the information in the appraisal for one transaction often is not utilized in connection with a separate transaction even if the assets are very similar.

### BRIEF SUMMARY OF THE INVENTION

In one aspect, a method for obtaining an appraisal is provided. The method comprises the steps of notifying at least one appraiser of an appraisal request, receiving, in electronic form, an appraisal from the appraiser, and storing the received appraisal, in electronic form, in a memory.

In another aspect, a method for operating a computer to obtain an appraisal is provided. The method comprises the steps of displaying an appraisal template including a plurality of fields to be populated by an appraiser, receiving data input by the appraiser in the template fields, and storing the received data in a database.

In still another aspect, a database for an appraisal management system is provided. The database comprises data corresponding to a plurality of appraisals, and data corresponding to a plurality of approved appraisers.

In yet another aspect, a system for receiving and managing appraisals is provided. The system comprises a database comprising data corresponding to completed appraisals, and a system server coupled to the database and configured to execute a search to identify appraisals stored in the database that meet pre-defined criteria.

### BRIEF DESCRIPTION OF THE DRAWINGS

FIG. 1 is a flow diagram illustrating tasks performed in connection with a network-based system for obtaining and managing appraisals.

FIG. 2 is a block diagram illustrating an example of a system architecture for a system that acquires and manages appraisals.

FIG. 3 illustrates data hierarchy for data stored in the database illustrated in FIG. 1.

FIG. 4 illustrates one embodiment of user interface logic for the system illustrated in FIG. 2.

FIG. 5 is an example screen shot of a web page for initiating a request for an appraisal.

FIG. 6 is a continuation of the web page illustrated in FIG. 5.

FIG. 7 is an example screen shot of a web page for an appraisal template.

FIG. 8 is a continuation of the web page illustrated in FIG. 7.

FIG. 9 is an example screen shot of a web page for attaching a photograph to an appraisal.

FIG. 10 is an example screen shot of a web page for submitting an appraisal.

FIG. 11 is a continuation of the web page illustrated in FIG. 10.

FIG. 12 is an example screen shot of a web page for requesting a report on region appraisal activity.

FIG. 13 is an example screen shot of a web page for requesting search results by equipment type.

### DETAILED DESCRIPTION OF THE INVENTION

Set forth below is a description of methods and systems for soliciting, submitting, and managing appraisals. While the methods and systems are sometimes described in the context of appraisals for specific types of assets, the methods and systems are not limited to practice in connection with any one specific asset type. For example, the methods and systems can be utilized in connection with both tangible and intangible assets.

Further, the methods and systems are described below as being practiced utilizing the Internet, which sometimes is referred to as the world wide web. The Internet, however, is one of many wide area networks and the methods and systems can be practiced in connection with many other wide area networks as well as local area networks, Therefore, the methods and systems are not limited to practice using the Internet and can be practiced using many other networks.

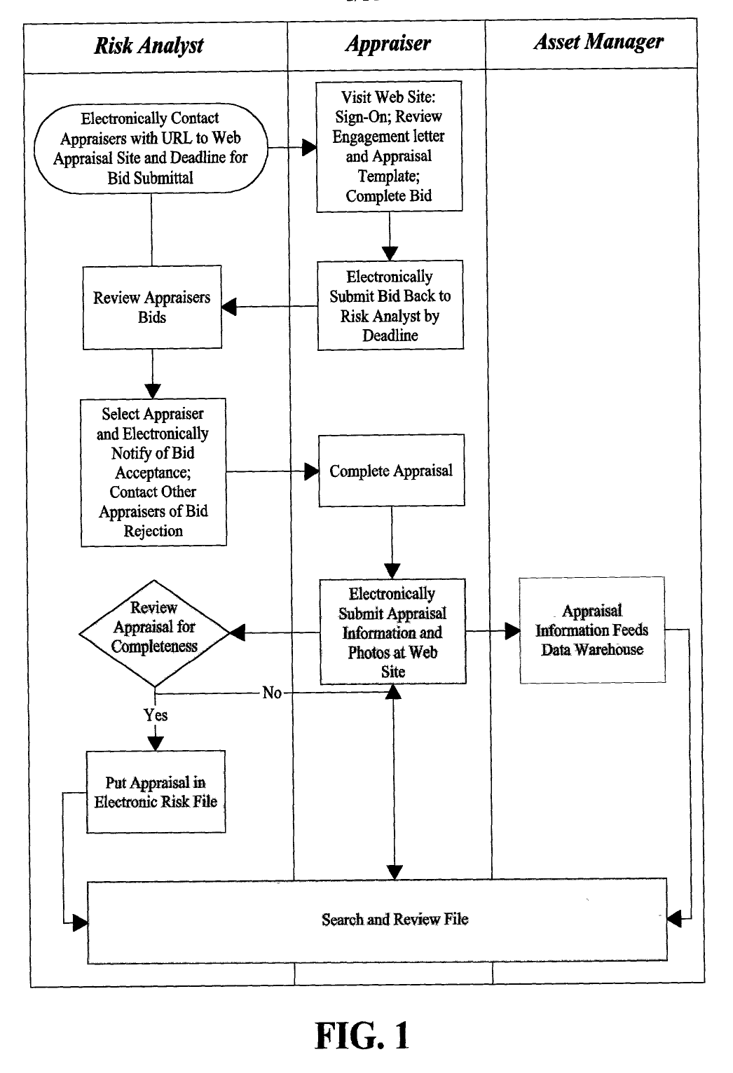

FIG. 1 is a flow diagram illustrating tasks performed in connection with a network-based system for obtaining and managing appraisals. Each task is in one of three columns, and each column is designated as being performed by one of a risk analyst, an appraiser, and an asset manager. A “risk analyst” is an individual, organization, or system (e.g., an automated process practiced on a computer) assigned with responsibility for obtaining appraisals. An “appraiser” is an individual, organization, or system (e.g., an automated process practiced on a computer) assigned with responsibility for completing appraisals. An “asset manager” is an individual, organization, or system (e.g., an automated process practiced on a computer) assigned with responsibility for managing assets owned by or subject to transaction involving the entity securing the appraisal.

While each task is designated in the example embodiment as being performed by one of the analyst, appraiser, or asset manager, each task is not necessarily performed by such designee in alternative embodiments. For example, the analyst and asset manager may be one individual or system, and therefore, all tasks designated as being performed by the analyst and manager may actually be performed by one individual, organization, or system.

Referring now specifically to FIG. 1, the tasks are performed by the respective designees using a system that includes computers coupled to the world wide web, sometimes referred to as the web, and such computers are accessible to at least the risk analyst and the appraiser. The system also includes a database server having a database that is accessible by the risk analyst and asset manager via a network (e.g., a local area network). In the example embodiment, an initial task is for the risk analyst to contact, via the web, appraisers and request each contacted appraiser to submit a bid to provide a specific a appraiser. In the example embodiment, details regarding the appraisal to be conducted are stored on a web page (e.g., an HTML page) that can be viewed by each appraiser via the Internet. The risk analyst, in communicating with each appraiser, provides each appraiser with the URL (uniform resource locator) for the HTML page along with a deadline (e.g., a designated date and/or time) by which the appraiser needs to submit a bid to provide an appraisal in order for the bid to be considered. Such communication from the risk analyst to each appraiser can be via electronic mail (e-mail), or via a web site using a communication tool such as the QuickPlace tool commercially available from Lotus Development Corporation, Cambridge, Mass.

Upon receipt of the request for bid, each contacted and authorized appraiser can view the appraisal details by visiting the web site. Specifically, upon arriving at the web site by entering the URL, further access to the web site is controlled by requiring each appraiser to complete a signon process including entry of a user name and password. If the entered user name and password are valid, then the user (i.e., the authorized appraiser) can view the appraiser details as well as the terms and conditions associated with submitting a bid. Such terms and conditions may be set forth in an engagement letter that also is viewable at the web site.

In addition, an appraisal template can be viewed at the site. The appraisal template is a standard form that the winning appraiser is to utilize, and complete, in connection with performing the appraisal to be conducted. By viewing the template during the bidding process, the bidding appraisers are able to understand the extent of effort required in order to submit an appraisal that conforms to the needs of the entity seeking the appraisal.

The selected appraisers who elect to submit a bid can submit such bids via e-mail, for example. Specifically, each bid request includes contact information for each appraiser to utilize in connection with such bid. If an appraiser elects to submit a bid, then the appraiser simply e-mails to the contact address(es) the amount the appraiser bids for the specific appraisal.

The “bid” can be in one of many forms. For example, an appraiser may submit a fixed fee “bid” which means that for the requested appraisal, the appraiser will charge the fee indicated regardless whether the appraiser costs are less than or exceed the fee amount. Alternatively, the appraiser may submit a not to exceed “bid” along with an hourly rate that applies up to the not to exceed amount. Of course, in the request for bid, the risk analyst can specify the type or types of bids that can be submitted.

The submitted bids are stored electronically by the risk analyst, and once the time has expired for submission of bids, the risk analyst then reviews the submitted bids. Generally, the risk analyst will select one appraiser who is notified that its bid has been accepted. Such notification can be made, for example, via e-mail. The risk analyst also may contact, e.g., via e-mail, the other appraisers who submitted bids to notify such appraisers that their bids have been rejected.

By soliciting bids from multiple appraisers as described above, it is believed that more competitive pricing can be obtained on performance of such appraisals. With some entities that require appraisals, however, soliciting bids on appraisals may not be effective and/or desirable. Therefore, the process of soliciting, receiving, and selecting bids for appraisals may not be utilized. Rather than soliciting, receiving, and selecting bids, such entities may simply request one or more appraisers to provide an appraisal on a specific asset. If such an approach is taken, then the process begins with submitting, e.g., via e-mail, a request to a selected appraiser to perform a specific appraisal.

Regardless of the manner in which the appraiser is selected, upon notification to the appraiser that an appraisal is to be conducted by such appraiser, the appraiser then proceeds to complete the appraisal. The electronic appraisal template described above is completed by the appraiser, and the appraisal is then submitted and saved in the database. An e-mail is sent to the risk analyst informing the analyst that the template has been submitted. The template, as described below in more detail, includes fields that are populated by the appraiser and then, upon the appraiser submitting the template, results in transmission of the appraiser entered information to the risk analyst and asset manager in accordance with a defined format.

The appraiser submitted information is reviewed by the risk analyst for completeness. Specifically, the analyst determines whether all required fields have been populated by the appraiser. If all the required fields have not been populated, the risk analyst contacts, e.g., via e-mail, the appraiser and request that the appraiser re-submit the appraisal with all required fields completed. The fully completed appraisal can then be re-submitted by the appraiser to the risk analyst and the asset manager.

When a complete appraisal is received by the risk analyst, then the risk analyst stores the appraisal in a “risk” file. The risk file is an electronic file for a specific transaction that includes information relating to the risk analysis performed in connection with that transaction. For example, in addition to an appraisal, prior to extending a loan, a financial institution may obtain credit rating and credit history information on the loan requester. The type of information stored in the risk file may vary depending on the transaction type. Such information may also be stored in the risk analysis file.

The risk analysis file, in the example embodiment, is stored in a data warehouse. The term data warehouse refers to a database server including a web appraisal database. In addition, the appraisal information is received by the asset manager, and such appraisal information is downloaded by the asset manager into a data warehouse. The asset manager therefore electronically stores all appraisals in one database so that any one or more of such appraisals can be used for future purposes.

With respect to the information stored in the data warehouse, the risk analyst can then access risk files that the risk analyst has access to, e.g., risk files for a designated geographic region, to review the appraisal associated with a specific transaction. In addition, the appraiser can search and review an appraisal that the appraiser had previously submitted, e.g., each appraiser accesses only the appraisals that the specific appraiser submitted. Further, the asset manager can access all appraisals, independent of the risk files.

The above described method facilitates requesting bids for performing specific appraisals, as well as obtaining appraisals and electronically storing such appraisals in a database. Appraisals can be retrieved from the database by searching the database. In addition, the stored appraisal information can be used to evaluate appraisers. For example, by simply retrieving an appraisal and comparing an appraised value to the price at which an asset was actually sold, the appraiser performance (e.g., appraisal too low, too high, or within a range satisfactory to the requesting entity) can be evaluated. Further, the valuations contained in stored appraisals can be utilized in determining a value for an asset yet to be appraised, or for an asset that has been appraised but the appraisal is being questioned. For example, a financial institution may regularly extend loans in particular industry, and the assets that serve as collateral for such loans may be very similar from loan to loan. The asset appraisal in an already completed appraisal can be useful in determining a value for an asset not yet appraised, or for confirming an appraisal value in a questionable appraisal.

The above described method is just one example of electronic solicitation, submission, and management of appraisals. Variations and additions can be made to such method. For example, the electronic submission of appraisals can be used separate from the method for electronically soliciting and receiving bids to perform appraisal work. In addition, the appraisals could be submitted to the risk analyst in paper form and then scanned and/or entered into a computer. Alternatively, the appraisals can be submitted via a hand held data device (e.g., a wireless device) so that the appraiser can submit an appraisal directly from the site of the equipment (e.g., the plant floor).

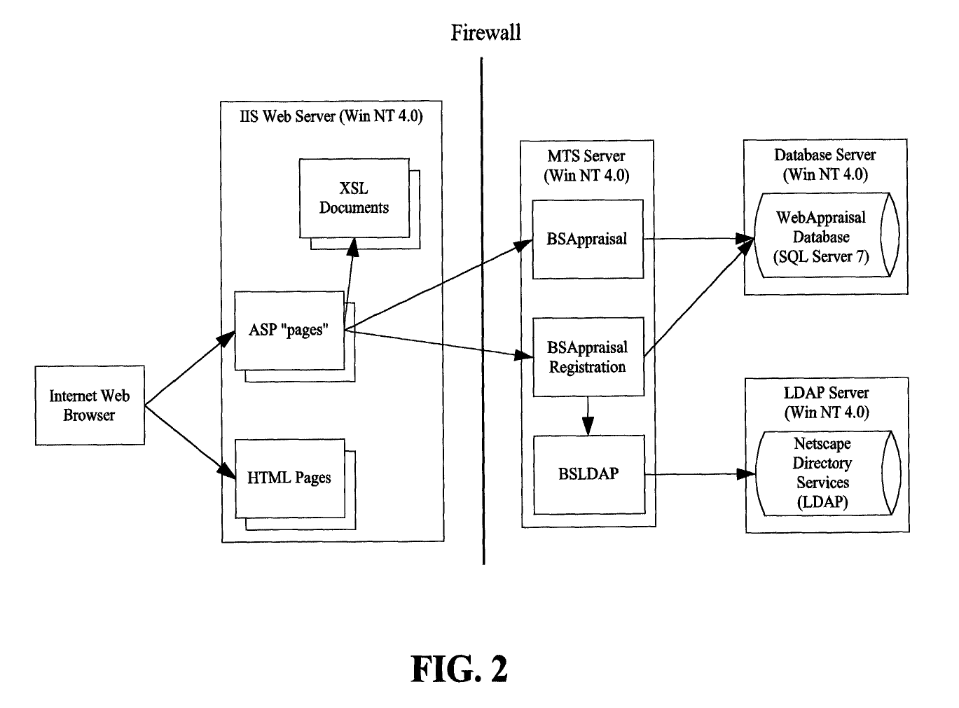

FIG. 2 is a block diagram illustrating an example of a system architecture for a system that acquires and manages appraisals. As shown in FIG. 2, the system is a three tiered architecture that includes a computer having an Internet web browser such as Explorer, commercially available from Microsoft Corporation, Redmond, Wash. The browser connects to a IIS web server having a Win NT 4.0 operating system, also commercially available from Microsoft Corporation, Redmond, Wash. XSL (eXtensible Stylesheet Language) documents, ASP (active server) pages, and HTML (hypertext markup language) pages are stored within the webserver.

The web server is coupled to an MTS server (i.e., a Microsoft transaction server), also having a Win NT 4.0 operating system. A firewall is provided between the web server and the MTS server. As is known in the art, the firewall is intended to prevent unauthorized access to the MTS server, the database server, and the LDAP (lightweight directory access protocol) server. The MTS server performs a number of functions as described below in more detail. The MTS server is coupled to a first database server having a Win NT 4.0 operating system and a SQL Server 7 type database, and to a second server having a Win NT 4.0 operating system and Netscape directory services.

In FIG. 2, the rightmost tier (i.e., the data tier) consists of two data stores. The first data store is the WebAppraisal database containing data specific to the Web Appraisal application, as described below. The second data store is the LDAP directory containing registered user details.

The middle tier (i.e., the business logic (or business service (BS)) tier) consists of three servers, namely the BSAppraisal server, the BSAppraisalRegistration server, and the BSLDAP server. BSAppraisal server retrieves and updates data in the WebAppraisal database. The BSLDAP server retrieves and updates data in the LDAP directory. The BSAppraisalRegistration server registers users on the Web Appraisal site by updating data in the WebAppraisal database and invoking the BSLDAP server to update the LDAP directory.

The leftmost tier (i.e., the presentation tier) consists of ASP pages, HTML pages, and XSL files. Some of the pages making up the web appraisal application are static (i.e., have no database data embedded within them). Others pages are dynamically loaded with database data when the page is displayed. The static pages are HTML pages directly accessible from the browser. The ASP pages generate HTML pages dynamically by invoking the components on the business service tier to pull data from the data tier and embedding this data into HTML templates (XSL files). The data retrieved from the business tier is in XML format. The XML data is merged with page templates (the XSL files), using XSLT (eXtensible Stylesheet Language Transformation), resulting in HTML pages containing the data. The HTML page is then sent to the browser for viewing by the end user.

In operation, the end user browser accesses both static HTML pages and dynamic pages by invoking “code-only” ASP pages. The ASP pages have no visual content. An HTML page is generated from the ASP page content by performing an XSLT transformation using a page specific XSL document and XML data.

The ASP pages are generated from XSL presentation “templates” from XSL documents. A registration ASP page is utilized for submitting a registration request to an appraisal registration process executed by the MTS server. The appraisal registration process calls the BSLDAP server to update the LDAP user data directly granting the user access to the site. The BSLDAP process accesses the LDAP directory using an active directory services interface (ADSI), commercially available from Microsoft Corporation, Redmond, Wash. In the appraisal request process, the web appraisal database is updated with registration information.

The ASP page displays data from the business services tier. This information is in XML format for transformation to HTML using the page specific XSL document. The data is requested from the web appraisal database via active data objects.

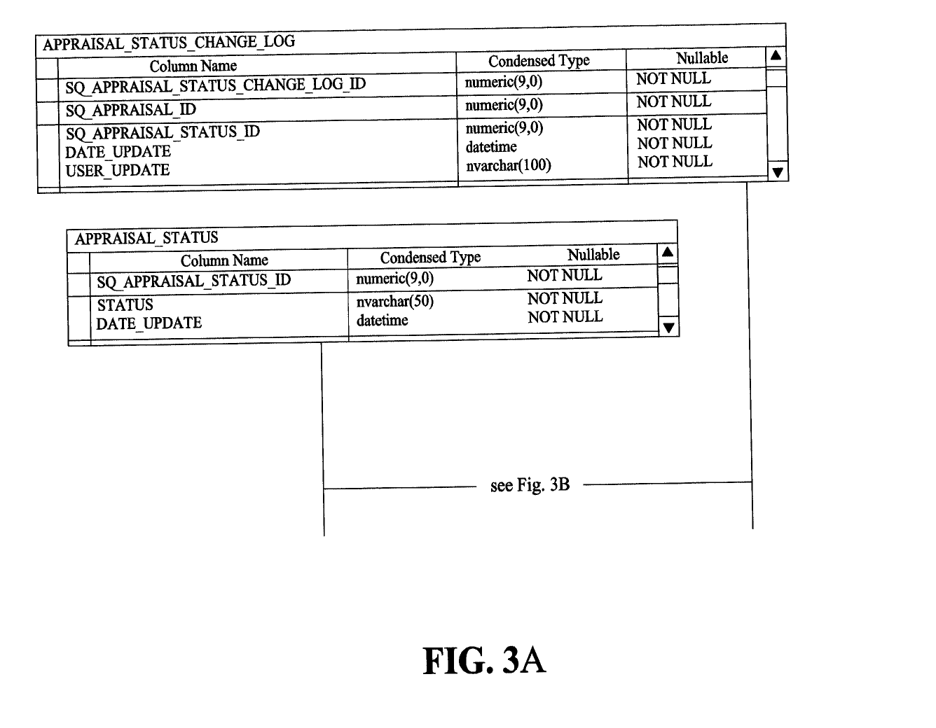

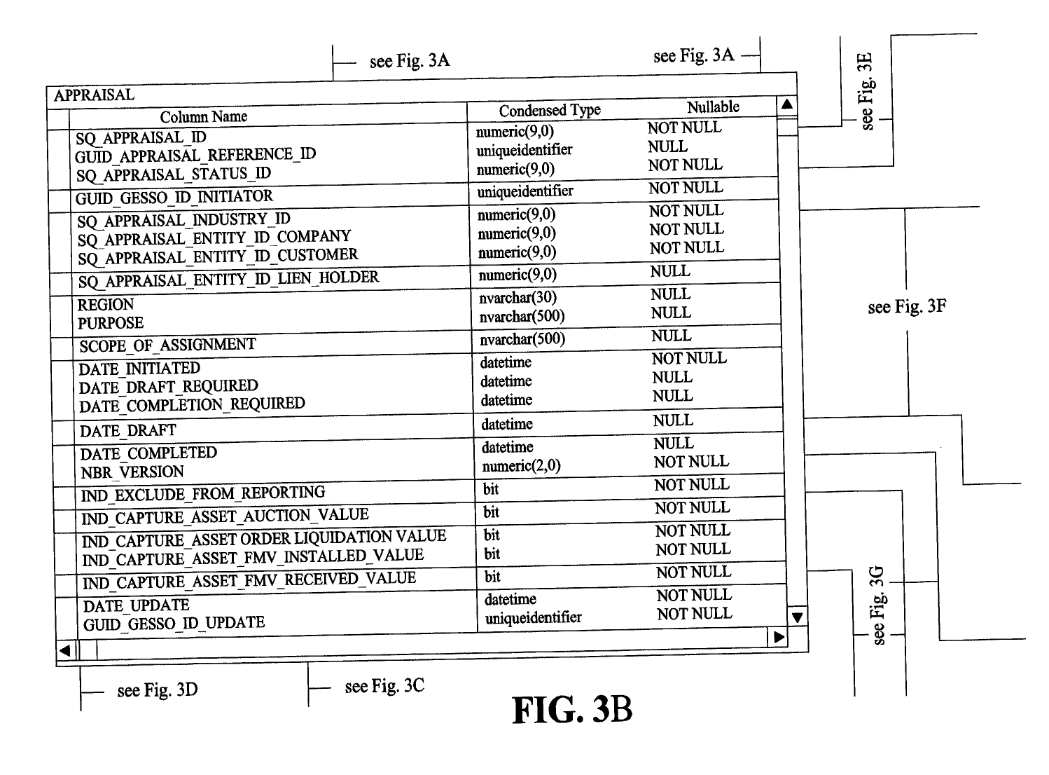

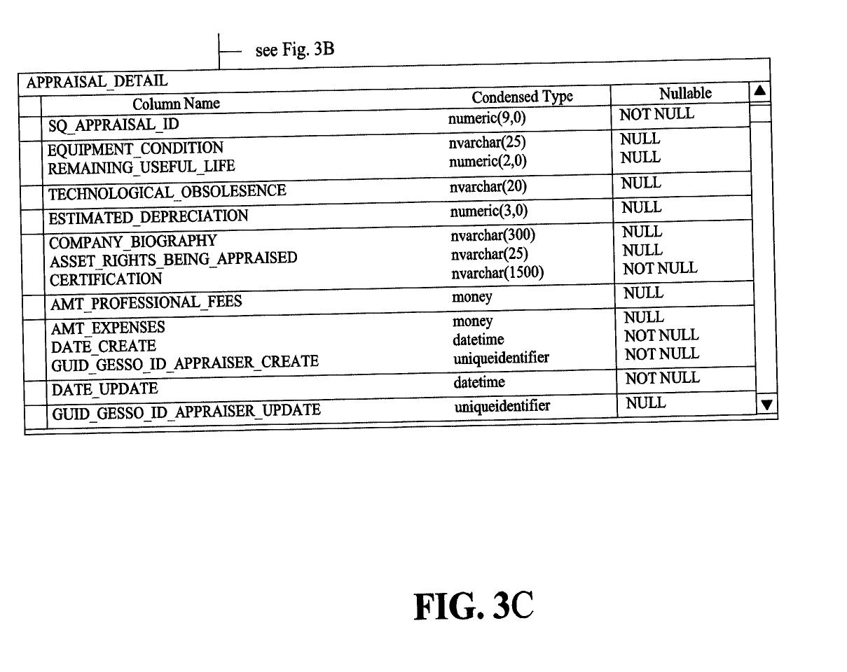

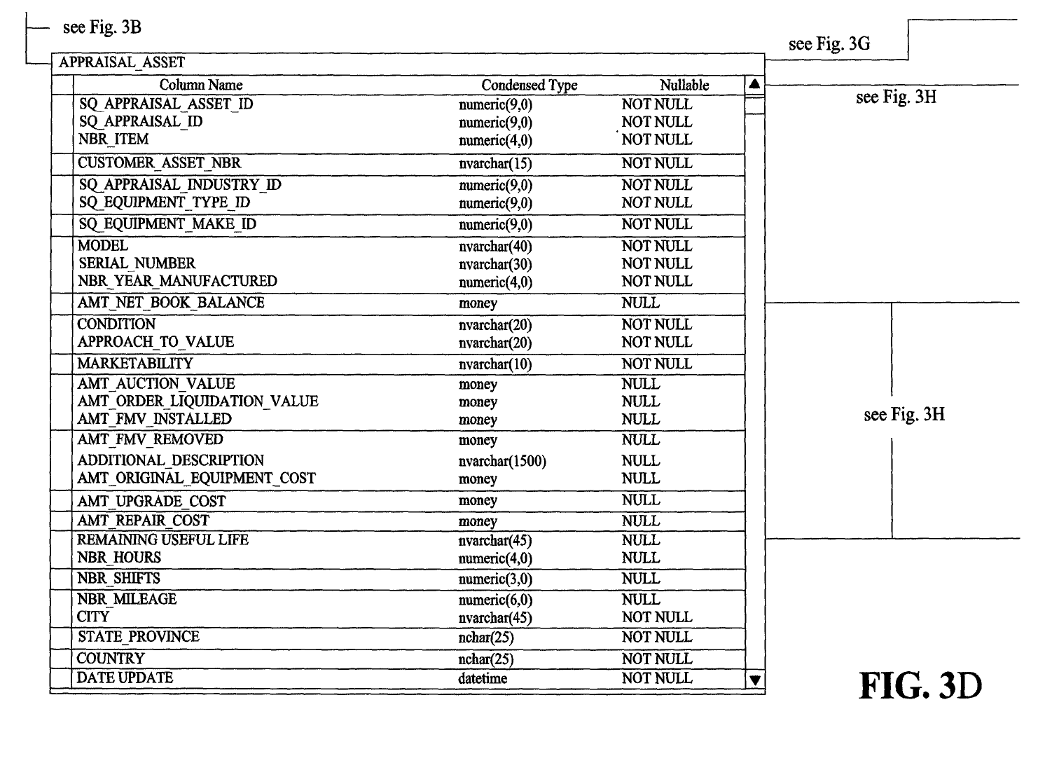

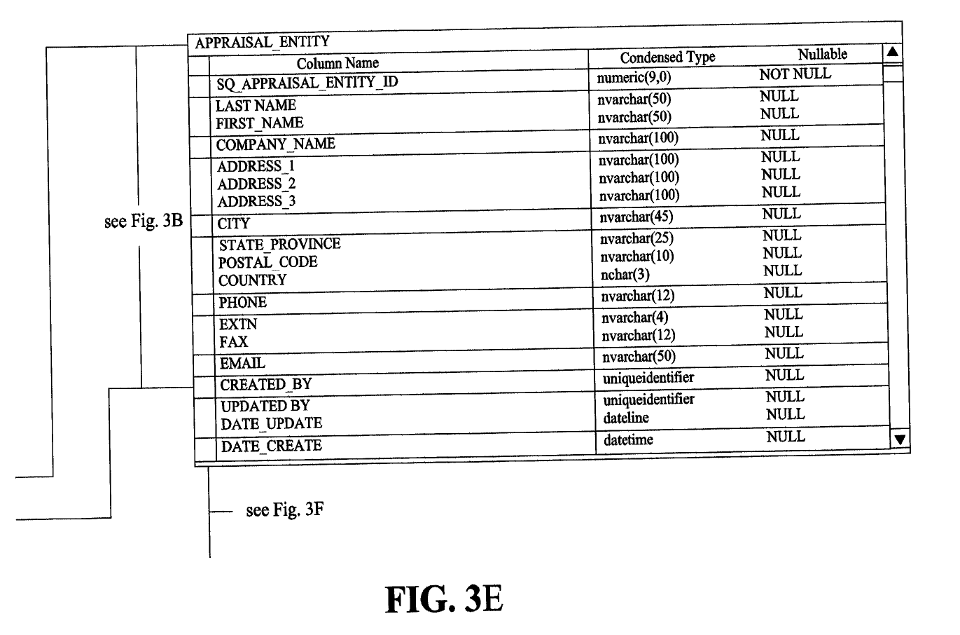

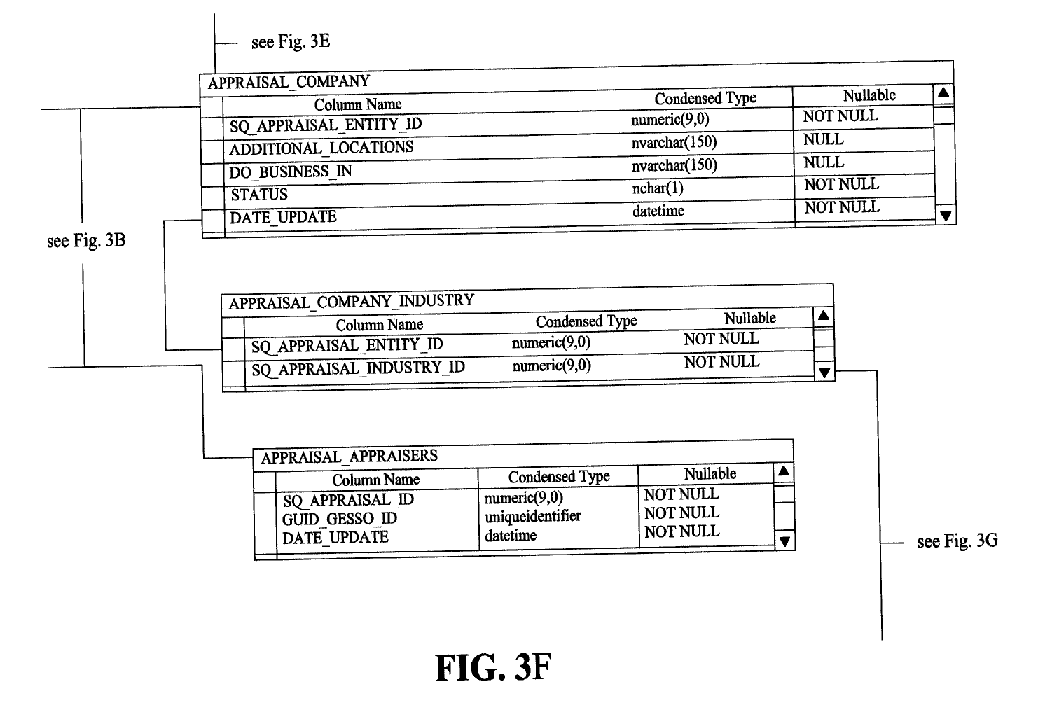

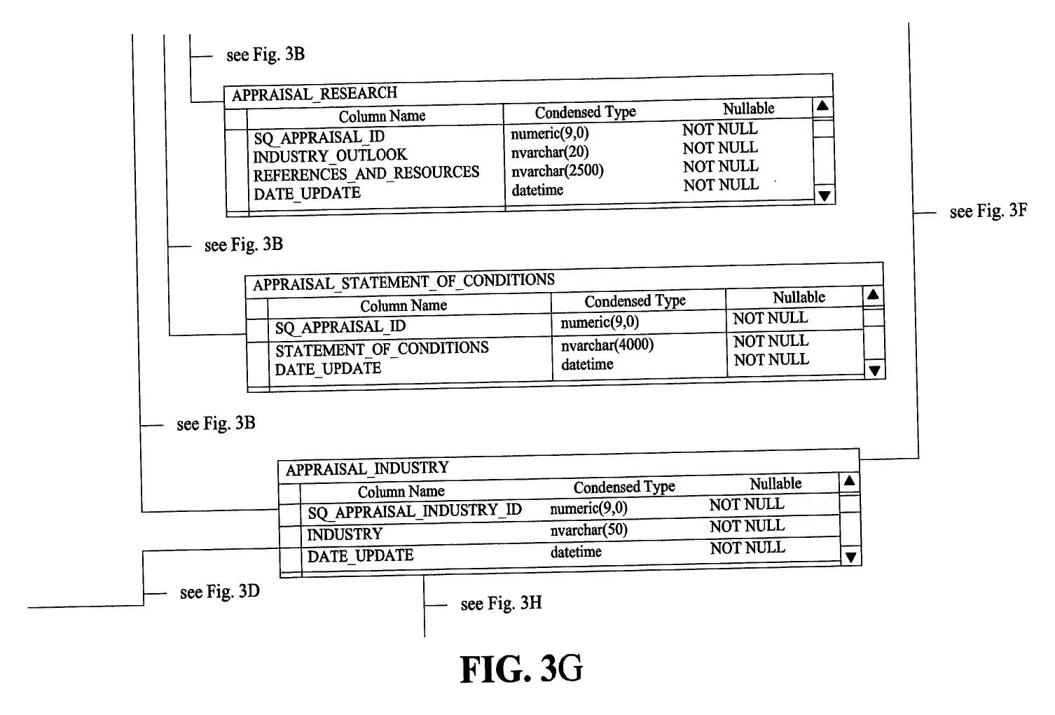

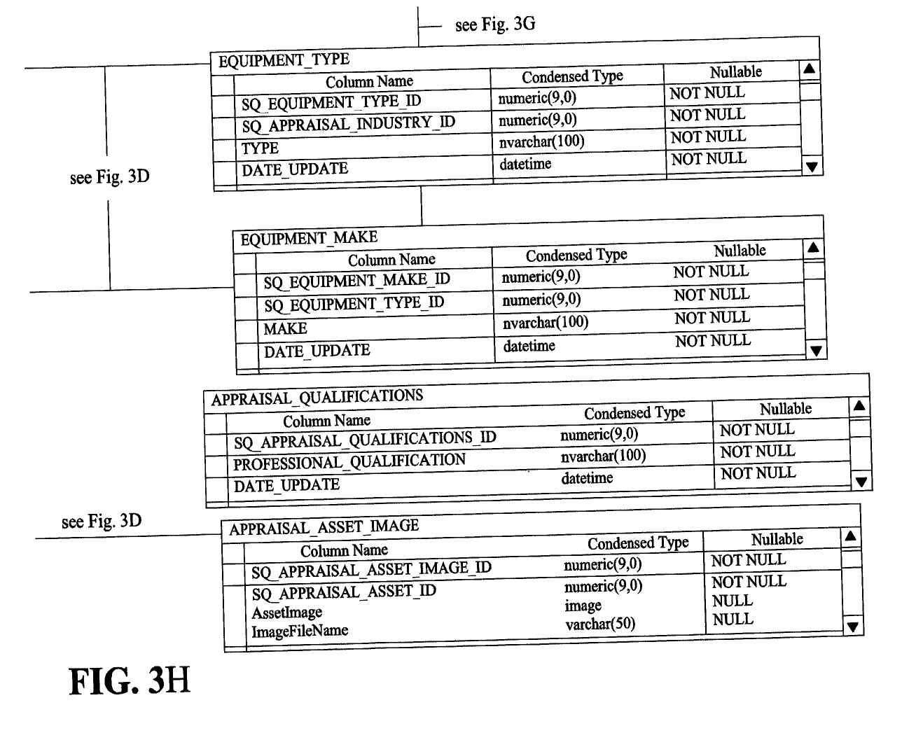

FIG. 3 illustrates data hierarchy for data stored in the database illustrated in FIG. 1. Specifically, the tables, as well as the table interconnectivity, in FIG. 3 illustrate data and associations of the data stored in the WebAppraisal database. In addition to identifying the specific data stored for each appraisal and appraiser, the tables in FIG. 3 designate the type of data stored for each category (e.g., numeric, unique identifier, non-variable character) as well as whether the entry can have a null value.

Referring now specifically to the tables, the APPRAISAL table contains details as entered by the risk analyst. The APPRAISAL APPRAISER table identifies each appraiser “tied” to each appraisal, i.e., the appraiser(s) that performed the appraisal. The APPRAISAL_ASSET table contains details on assets that are appraised as part of an appraisal. The APPRAISAL_ASSET_IMAGE table contains images uploaded for a given asset. The APPRAISAL_COMPANY table contains appraisal company specific details. The APPRAISAL_COMPANY_INDUSTRY table addresses the issue that an appraisal company can perform appraisals in one or more industries. The APPRAISAL_COMPANY_INDUSTRY table junction record resolves this many-to-many relationship between APPRAISAL_COMPANY and APPRAISAL_INDUSTRY. The APPRAISAL_DETAIL table is an appraisal level detail entered by the appraiser. This table does not include asset level details. The APPRAISAL_ENTITY table contains details on entities (company, customer, debtor) related to an appraisal. The APPRAISAL_INDUSTRY table contains industries to which an appraisal may apply. The APPRAISAL_RESEARCH table contains research details for appraisals.

The APPRAISAL_STATEMENT_OF_CONDITIONS table contains statements of limiting conditions for appraisals. More specifically, such limiting conditions identify the conditions (e.g., tasks the appraiser did and did not perform in completing the appraisal) that apply to the appraisal. The APPRAISAL_STATUS table contains statuses of appraisals. Valid values include, for example, setup, new, partial, draft, final. The APPRAISAL_STATUS_CHANGE_LOG table tracks changes to the status of an appraisal, when the change was made, and who made the change. The APPRAISER_QUALIFICATIONS table contains appraiser qualifications. The qualifications are used, for example, when registering an appraiser. The EQUIPMENT_MAKE table contains an identification of the make of equipment subject to an appraisal. Each make is associated with a specific EQUIPMENT_TYPE. The EQUIPMENT_TYPE table contains equipment type details. Each equipment type is associated with a specific APPRAISAL_INDUSTRY.

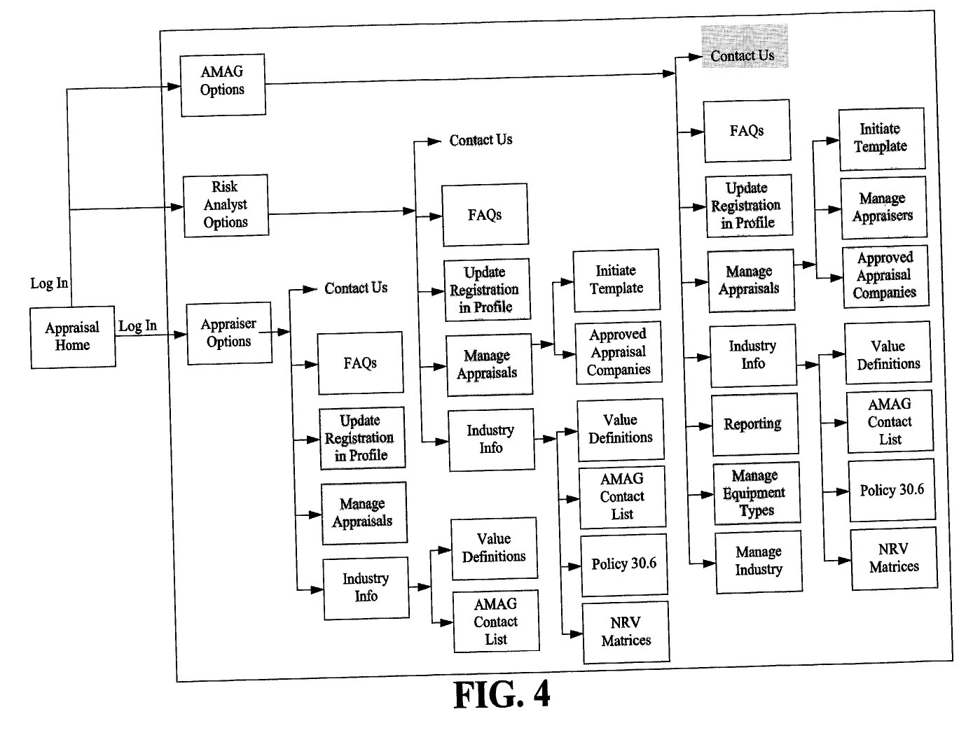

FIG. 4 illustrates one embodiment of user interface logic for the system illustrated in FIG. 2. More specifically, FIG. 4 illustrates the pages (HTML and ASP pages) that are selectable by each type of user, i.e., appraiser, risk analyst, and asset manager. Once a user arrives at the designated web site, the user logs in. Based on the log in, the system determines the user type (e.g., each authorized user is designated as a specific user type which is stored in the web appraisal database). If the user is an appraiser, then the user has access to appraiser designated information. If the user is a risk analyst, then the user has access to risk analyst designated information. If the user is an asset manager, then the user has access to asset manager information.

Generally, each appraiser has access to general pages (e.g., Contact Us, Frequently Asked Questions (FAQ), as well as to data relating specifically to that appraiser (Update Registration Profile), its specific appraisals (Manage Appraisals), and to industry information (Industry Info).

Each risk analyst has access to the same pages that the appraiser has access to, except that rather than being limited to access to a specific appraiser, the risk analyst has access to data relating to all appraiser and appraisals in a pre-designated region. In addition, the risk analyst has access to pages relating to company policies and practices (e.g., Policy 30.6 refers to an internal corporate policy for capital investments) and NRV (net return value) matrices. Each asset manager has access to all the pages, including pages the risk analyst has access to as well as to pages for managing appraisers, reporting, managing equipment types, and managing by industry.

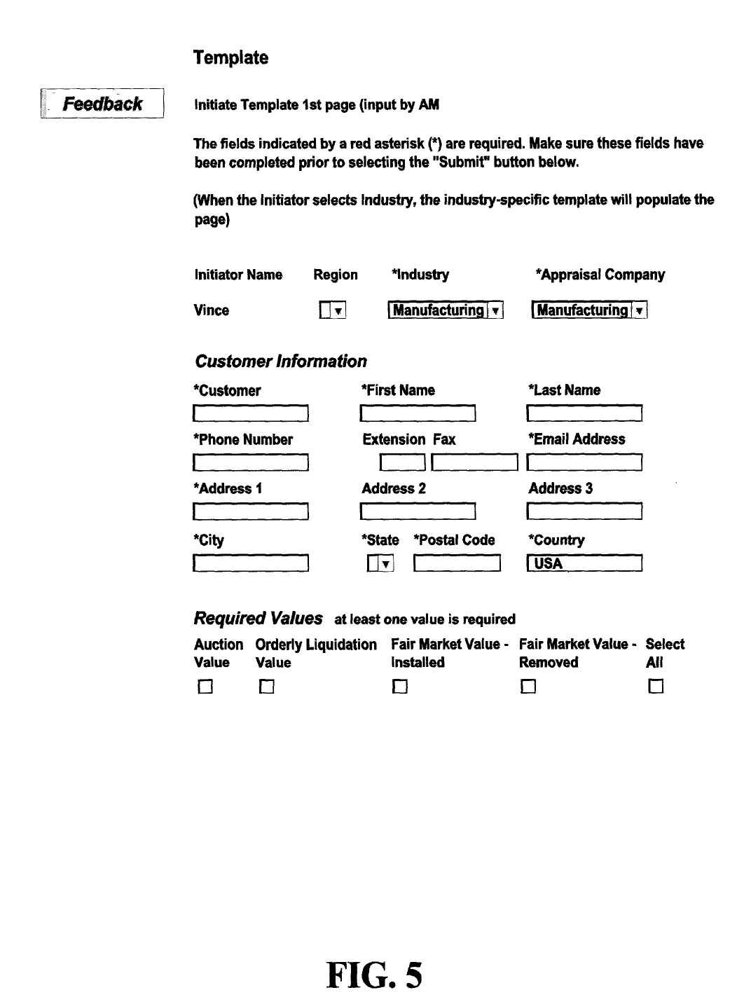

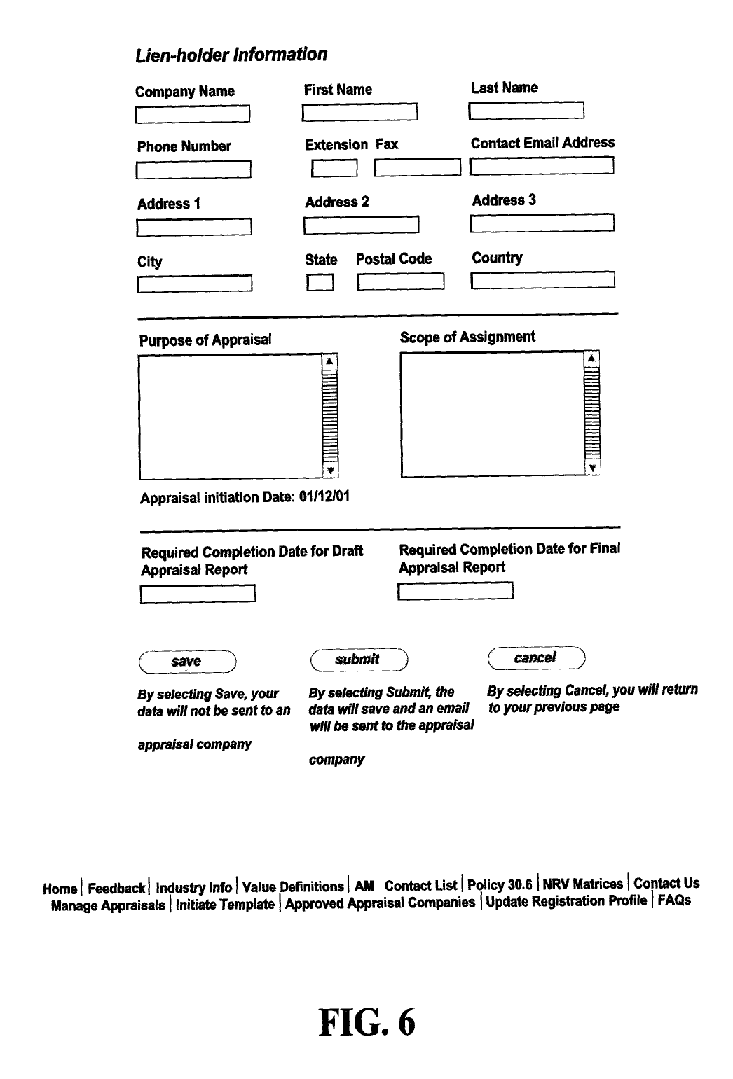

FIGS. 5 and 6 illustrate an example web page for initiating a request for an appraisal. Specifically, an asset manager (AM) completes the fields including customer information, required values, and lien-holder information. The asset manager also provides additional information including required completion date for a draft and for a final appraisal report. Once the AM has completed the required fields, the AM can then select “submit” to have the request sent to an appraisal company. The appraisal company that receives the request can be selected based on industry or using other criteria, e.g., a bid process can be used. Alternatively, if the AM is not yet ready to submit the appraisal to an appraisal company, the AM can save the data entered into the template or cancel the data and return to a previous page.

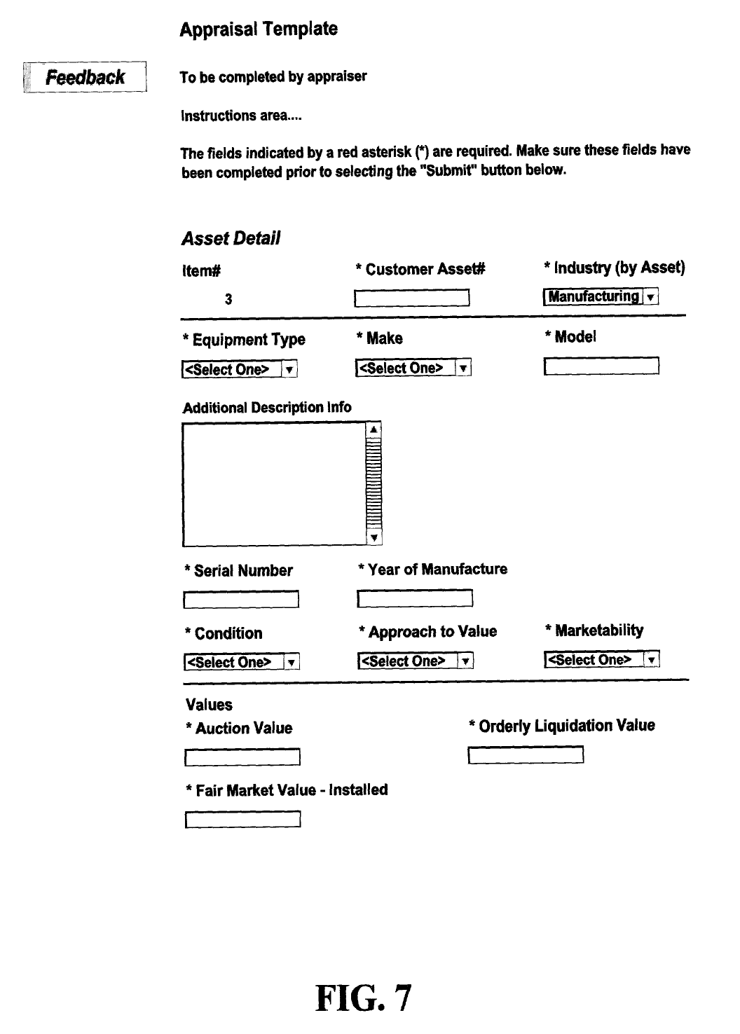

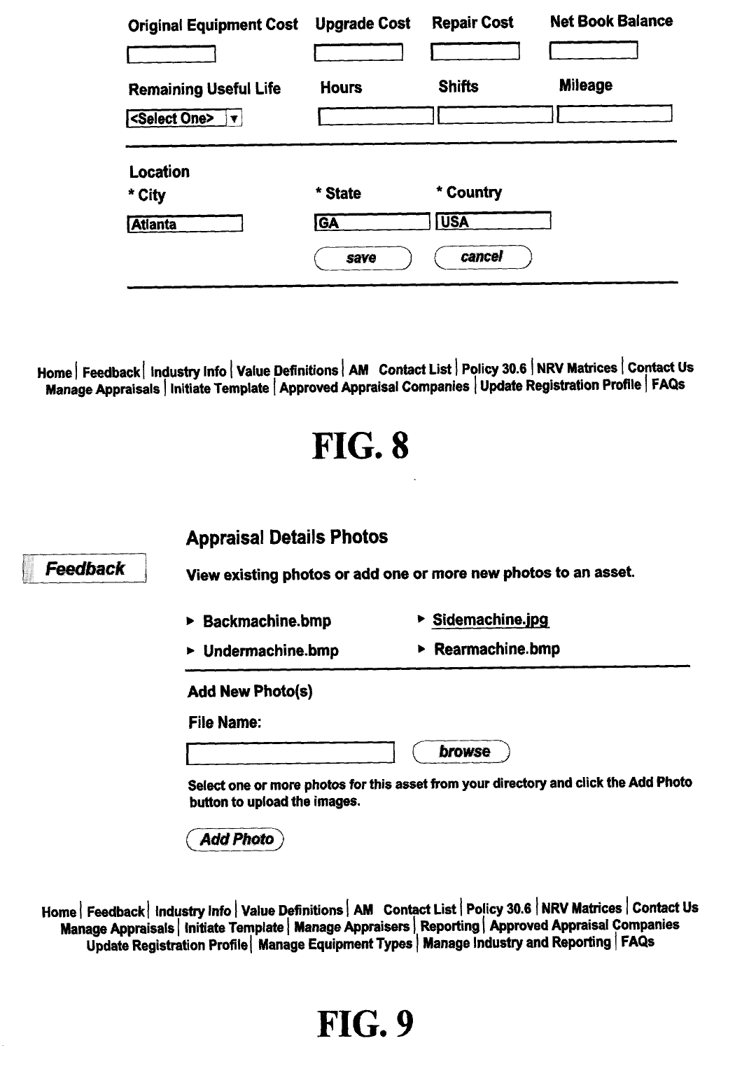

FIGS. 7 and 8 illustrate an example web page for an appraisal template. The template is completed by the appraiser and includes various information typically required in connection with an appraisal. The appraiser can attach a photograph to the appraisal by selecting “Add Photo” on the web page illustrated in FIG. 9. The appraisal template is used by the appraiser as the appraiser performs the appraisal.

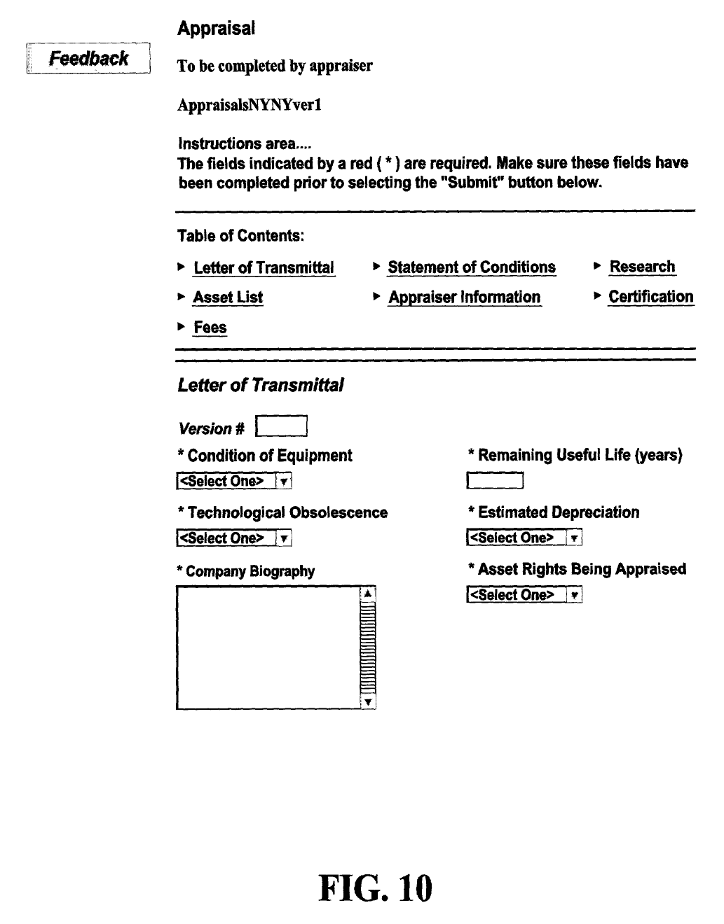

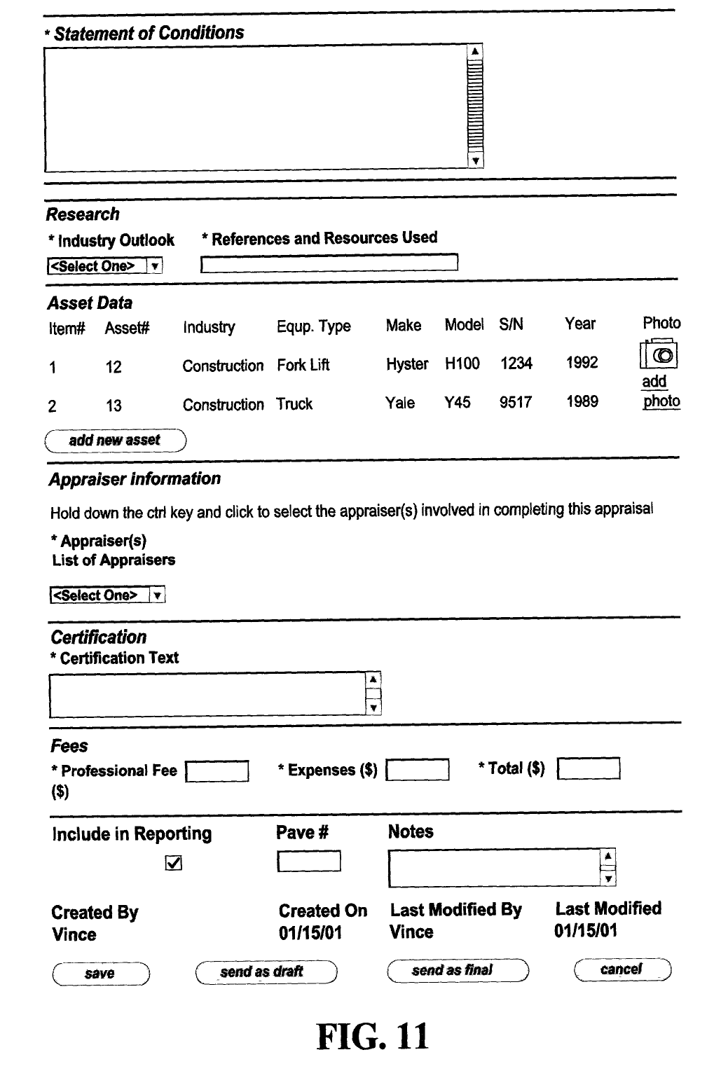

FIGS. 10 and 11 illustrate an example web page for submitting an appraisal. Specifically, once the appraiser has collected the necessary information to complete an appraisal using the template illustrated in FIG. 7, the appraiser then completes a formal appraisal using the template illustrated in FIGS. 10 and 11. The formal appraisal template also provides for entries regarding the appraisers fees and expenses. The formal appraisal can be submitted in draft form or in final form for review by the risk analysis and asset manager. The timing for submission of the draft form and final form is defined in the request initially sent to the appraiser.

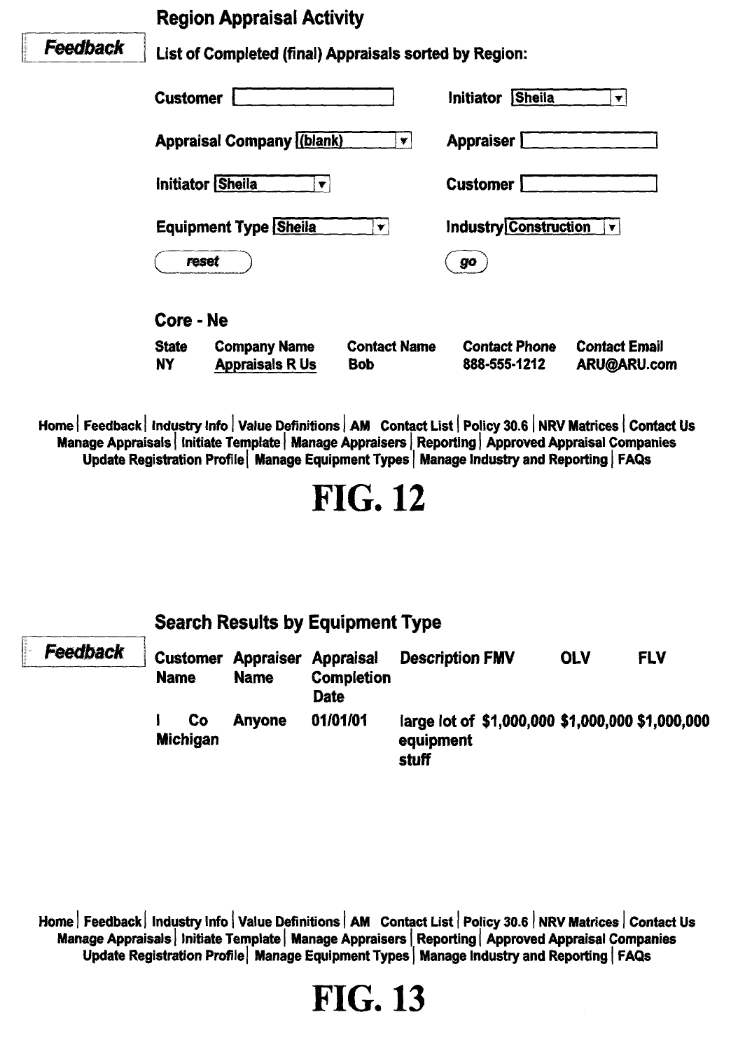

FIG. 12 is an example screen shot of a web page for requesting a report on region appraisal activity. With the appraisal data stored in the web appraisal database, many different reports can be generated and the region appraisal activity report is one example of such a report. Regions can be defined domestically (e.g., North East, South East, Mid West) as well as internationally.

FIG. 13 is an example screen shot of a web page for displaying search results by equipment type. An asset manager, for example, can search the web appraisal database to identify appraisals by equipment type. The appraisals can then be reviewed by the asset manager to determine, for example, whether an appraisal of a particular asset of the same type of equipment is valid.

The above described system can be used for many different applications, including predicting appraiser performance as well as for generating appraisals. For example, to generate an appraisal, the user searches the database to identify appraisals for equipment at least similar to, if not identical, the equipment to be appraised. The search request includes, for example, the type of equipment and year of manufacture. Data retrieved from the search request is then used to generate an appraisal. For example, adjustments to the appraisal price retrieved from the database are made based on differences between the appraised equipment and the equipment to be appraised, e.g., year of manufacture, condition of equipment. A predetermined function is associated with each meaningful appraisal parameter to generate an appraised value. For example, a function can be defined to adjust the appraisal price by a pre-set number of dollars based on the difference between the age of the appraised equipment and the age of the equipment to be appraised. To predict appraiser performance, data can be retrieved from the database for at least one appraisal performed by the appraiser, e.g., by defining a search to locate appraisals performed by a specific appraiser. The appraisals retrieved from the database are specified as being appraisals performed on assets that were subsequently sold. The asset selling price is then compared to the appraised value from the appraisal. A difference between the appraised value and the price at which the appraised asset was sold is then determined. Based on the magnitude of this difference, the accuracy of the appraiser can be predicted, e.g., if the asset selling price is more than 10% less than the appraised price is greater than 10%, then the appraiser can be categorized as being too aggressive in determining appraisal prices.

While the invention has been described in terms of various specific embodiments, those skilled in the art will recognize that the invention can be practiced with modification within the spirit and scope of the claims.

What is claimed is:

1. A system comprising:
a first database for storing data for an appraisal application;
a second database for storing data for registered users;
a business service server coupled to said first and second databases, said server programmed to:
retrieve and update data in said appraisal application database, and
retrieve and update data in said registered user database, and
a web server coupled to said business service server for causing web pages for appraisals to be displayed to an appraiser, at least some of said pages comprising an appraisal application.

2. A system according to claim 1 wherein said business server comprises an appraisal server, an appraiser registration server, and a directory server, and wherein said appraisal server retrieves and updates data in said first database, said directory server retrieves and updates data in said registered user database, and said appraiser registration server updates data in said registered user database.

3. A system according to claim 1 wherein said pages comprise ASP pages and HTML pages, and wherein XSL files are stored in said web server.

4. A system according to claim 1 further comprising a user terminal comprising a browser, said browser configured to communicate with said web server.

5. A three tiered system for receiving and storing appraisals, said system comprising:
a first tier comprising a first database containing data for an appraisal application, and a second database containing data for registered users;
a second tier comprising an appraisal server in communication with said first database, an appraisal registration server in communication with said second database, and a directory server in communication with said second database; and
a third tier comprising a web server in communication with said appraisal server and said appraisal registration server, said web server comprising web pages comprising a web application.

6. A system according to claim 5 wherein said web pages comprise ASP pages and HTML pages, and wherein said web server further comprises XSL files.

7. A system comprising:
a database comprising data corresponding to completed appraisals; and
a processor coupled to said database and configured execute a search to identify appraisals stored in said database that meet pre-defined criteria.

8. A system according to claim 7 wherein said processor is further configured to receive data corresponding to prospective users and provide the prospective user data to the database.

9. A system according to claim 7 further comprising a web server coupled to said processor, said web server comprising a memory having a plurality of HTML pages stored therein.

10. A system according to claim 7 further comprising a user terminal comprising a browser, said browser configured to communicate with said web server.

11. A method for obtaining an appraisal, said method comprising the steps of:
notifying at least one appraiser of an appraisal request;
receiving, in electronic form, an appraisal from the appraiser; and
storing the received appraisal, in electronic form, in a memory.

12. A method according to claim 11 wherein notifying at least one appraiser of an appraisal request comprises the steps of contacting a plurality of appraisers and requesting each appraiser to submit a bid to perform an appraisal.

13. A method according to claim 12 further comprising the step of receiving a plurality of bids and selecting an appraiser based at least in part on the bid submitted by that appraiser.

14. A method according to claim 13 further comprising the step of notifying the selected appraiser that the bid has been accepted and that the appraiser is to perform the appraisal.

15. A method according to claim 11 wherein the appraisal is received from a wireless device.

16. A method for operating a computer to:
display an appraisal template including a plurality of fields to be populated by an appraiser;
receive data input by the appraiser in the template fields; and
store the received data in a database.

17. A method according to claim 16 wherein to display an appraisal template, the computer causes a web page to be displayed at an appraiser device, the web page comprising a plurality of fields to be populated by the appraiser in order to complete the appraisal.

18. A method according to claim 17 wherein the user device comprises a wireless device.

19. A method according to claim 16 further comprising operating the computer to search the database to retrieve a stored appraisal.

20. A method according to claim 16 further comprising operating the computer to search the database to retrieve data corresponding to a requested report.

21. A method according to claim 16 wherein the received data comprises an image of the appraised asset.

22. A database comprising:
data corresponding to a plurality of appraisals,
data corresponding to a plurality of approved appraisers.

23. A database according to claim 22 where said appraisal data comprises data identifying the asset appraised, and data identifying the appraiser that performed the appraisal.

24. A database according to claim 22 further comprising data corresponding to industries in which at least some appraised assets are utilized.

25. A database according to claim 22 further comprising data corresponding to an image of an appraised asset.

26. Apparatus comprising:
means for displaying an appraisal template to an appraiser;
means for receiving said appraisal in electronic form; and
means for storing said received appraisal.

27. Apparatus according to claim 26 wherein said displaying means comprises a web server coupled to a user terminal comprising a browser.

28. Apparatus according to claim 26 wherein said receiving means comprises a web server coupled to a system server.

29. Apparatus according to claim 26 wherein said storing means comprises a database server comprising a database.

30. A computer-readable medium executable by a computer for controlling the computer to:
cause to be displayed, to a user, web pages comprising an appraisal template; and
process data entered into the template and received from the user, said processing comprising the step of storing said appraisal in a database.

31. A computer readable medium according to claim 30 wherein said processing further comprises the steps of retrieve and update data in an appraisal application database, and retrieve and update data in a registered user database.

32. A computer readable medium according to claim 30 wherein said pages comprise ASP pages and HTML pages.

33. A method for operating a computer for generating an appraisal, the computer coupled to a database comprising appraisal information for a plurality of appraisals, said method comprising the steps of:
searching the database to identify appraisals for equipment at least similar to the equipment to be appraised;
retrieving data from the identified appraisals; and
generating an appraisal for the equipment based on the retrieved data.

34. A method according to claim 33 wherein searching the database comprises prompting a user to input information identifying the equipment to be appraised by equipment type and year of manufacture.

35. A method according to claim 33 wherein generating an appraisal comprises executing a predefined function based on at least one of the equipment type and equipment year.

36. A method for predicting appraiser performance, said method comprising the steps of:
retrieving data from a database and for at least one appraisal performed by the appraiser, the appraisal being for an asset that was sold; and
comparing the appraised value from the appraisal with an actual price at which the appraised asset was sold.

37. A method according to claim 36 wherein a computer is coupled to the database, and wherein retrieving data comprises the step of entering into the computer information identifying the appraiser.

38. A method according to claim 36 wherein comparing the appraised value from the appraisal with an actual price at which the appraised asset was sold comprises the step of determining a difference between the appraised value and the price at which the appraised asset was sold.

39. A method for obtaining a plurality of bids to provide an appraisal, said method comprising the steps of:
notifying a plurality of appraiser of an appraisal request;
receiving, in electronic form, a plurality of bids from at least some of said notified appraisers;
selecting one of the bids; and
notifying the appraiser of the selected bid that the appraiser is to perform the appraisal in accordance with the bid.

40. A method according to claim 39 wherein notifying the plurality of appraisers comprises the step of transmitting electronic mails messages to at least some of the appraisers.

41. A method according to claim 39 wherein receiving the plurality of bids comprises the step of receiving at least some of the bids via electronic mal.

42. A method according to claim 39 further comprising the step of causing information related to the appraisal to be accessible via a web site.

43. A method according to claim 42 wherein the appraisal information comprises an appraisal template.

44. A method according to claim 39 further comprising the step of storing the received bids in an electronic database.

45. A method for submitting an appraisal, said method comprising the steps of:
entering data into an electronic appraisal template; and
electronically transmitting the entered appraisal data to a processor.

46. A method according to claim 45 further comprising the step of saving the appraisal data in a database.

47. A method according to claim 45 further comprising the step of transmitting an electronic notification to a risk analyst that appraisal data has been submitted.

48. A method according to claim 45 wherein transmitting the entered appraisal data is performed by at least one of a wireless device and a computer.
